(19) United States
(12) Patent Application Publication
(10) Pub. No.: US 2019/0288865 A1
(43) Pub. Date: Sep. 19, 2019

(54) CONTROL METHOD, CONTROL APPARATUS AND CONTROL SYSTEM FOR A WASHING MACHINE

(71) Applicant: QINGDAO HAiER WASHING MACHINE CO., LTD., Qingdao, Shandong (CN)

(72) Inventors: Hai SHU, Qingdao, Shandong (CN); Sheng XU, Qingdao, Shandong (CN); Zhenxing HUANG, Qingdao, Shandong (CN); Gaoxian ZHANG, Qingdao, Shandong (CN)

(21) Appl. No.: 16/317,534

(22) PCT Filed: Jul. 11, 2017
(86) PCT No.: PCT/CN2017/092476

§ 371 Date: Jan. 11, 2019

(30) Foreign Application Priority Data
Jul. 11, 2016 (CN) 201610541591.2

(51) Int. Cl. H04L 12/28; G06F 16/9538; D06F 37/42; D06F 33/02; D06F 39/00; G08B 21/18; G06F 11/30

(52) U.S. Cl. CPC H04L 12/2803; G06F 16/9538; D06F 37/42; H04L 2012/2847; D06F 39/005; G08B 21/187; G06F 11/3072; D06F 33/02

(57) ABSTRACT

Disclosed is a control method, control apparatus and control system for a washing machine. The method includes: receiving device information and failure information of the washing machine sent by the washing machine; querying an installation information database for a first number of washing machines having same device information in a preset area; querying an alarm history record database for a second number of washing machines having same failure information within a first preset time duration in the preset area if the first number is greater than a first preset threshold; and determining a failure cause based on the first number and the second number.

### TECHNICAL FIELD

The present disclosure relates to the technical field of washing machines, for example, to a control method, control device and control system for a washing machine.

### BACKGROUND

With the popularity of washing machines and the development of control technologies, smart washing machines appear. Washing machines bring great convenience to people and free people from heavy laundry labor. However, once a washing machine fails, a user needs to determine failure causes, contact an after-sale personnel of a manufacturer of the washing machine, and ask the after-sale personnel to carry out on-site maintenance. The process is cumbersome and wastes a lot of time for the user. The causes of abnormal water feeding in the washing machine include: low tap water pressure, slow water feeding and loss of tap feedwater; and water leakage from the washing machine. When a water leakage failure occurs in the washing machine, the after-sale personnel needs to carry out the on-site maintenance.

When the washing machine fails, the washing machine only prompts an alarm. For example, if a water inlet valve is opened while a set water level is not reached within set time (for example, 1 to 10 minutes), the washing machine prompts a water feeding abnormality alarm. The washing machine itself may not be able to accurately locate a failure cause. The failure cause needs to be determined by the user himself/herself, so user experiences are degraded. Alternatively, a corresponding detection sensor needs to be added to accurately locate the failure cause, while the addition of the detection sensor will increase cost of the washing machine.

### SUMMARY

A control method for a washing machine can implement an automatic determination of a water feeding failure of the washing machine and user experiences are improved.

A control apparatus for a washing machine can implement the control method described above, and can enable the washing machine to automatically determine a water feeding failure.

A control system for a washing machine includes a control apparatus and a washing machine.

The control method for the washing machine includes:

receiving device information and failure information of the washing machine sent by the washing machine;

querying an installation information database for a first number of washing machines having same device information in a preset area;

querying an alarm history record database for a second number of washing machines having same failure information within a first preset time duration in the preset area if the first number is greater than a first preset threshold; and

determining a failure cause based on the first number and the second number.

Optionally, the failure information is that water feeding is abnormal.

Optionally, the determining the failure cause based on the first number and the second number includes:

determining the failure cause of the washing machine as low tap water pressure or loss of feedwater if the second number is greater than a second preset threshold, and determining the failure cause of the washing machine as water leakage from the washing machine if the second number is less than or equal to the second preset threshold.

Optionally, the method further includes: updating the alarm history record database according to the failure cause.

Optionally, the method further includes: sending the failure cause to the washing machine so that the washing machine displays the failure cause, and sending the failure cause to a user terminal for prompting a user.

Optionally, the method further includes: sending the failure information to the washing machine so that the washing machine displays the failure information and sending the failure information to a user terminal for prompting a user, if the first number is less than or equal to the first preset threshold.

The control apparatus for a washing machine includes:

an information receiving module, configured to receive device information and failure information of the washing machine sent by the washing machine;

a first query module, configured to query an installation information database for a first number of washing machines having same device information in a preset area;

a second query module, configured to query an alarm history record database for a second number of washing machines having same failure information within a first preset time duration in the preset area if the first number is greater than a first preset threshold; and

a failure cause determination module, configured to determine a failure cause based on the first number and the second number.

Optionally, the failure information is that water feeding is abnormal.

Optionally, the failure cause determination module is configured to:

determine the failure cause of the washing machine as low tap water pressure or loss of feedwater if the second number is greater than a second preset threshold, and determine the failure cause of the washing machine as water leakage from the washing machine if the second number is less than or equal to the second preset threshold.

The control system for a washing machine includes:

any one of the control apparatus for the washing machine described above, where the control apparatus is arranged in a server;

the washing machine, including a control module, a data communication processing module and a display module, where the control module is configured to control water feeding of the washing machine, determine whether a water level of the washing machine reaches a set value within a second preset time duration, control a water inlet valve to be closed if the water level of the washing machine reaches the set value within the second preset time duration, and control the data communication processing module to send device information and failure information of the washing machine if the water level of the washing machine does not reach the set value within the second preset time duration; where the data communication processing module is configured to transmit the device information and the failure information to the server, and receive a failure cause sent by the server; and where the display module is configured to display the failure cause of the washing machine; and

a user terminal, configured to receive the failure cause and the failure information sent by the server.

A computer-readable storage medium, configured to store computer-executable instructions for executing the method described above.

A server includes:

at least one processor; and

a memory which is communicatively connected to the at least one processor; where

the memory stores instructions which may be executed by the at least one processor, and the at least one processor executes the instructions to execute the above-mentioned control method for the washing machine.

The above-mentioned control method, control apparatus and control system for the washing machine can determine, via the big data, that the failure is caused by slow water feeding due to low tap water pressure or by loss of tap feedwater if the number of washing machines having the same alarm within the preset time duration in the preset area exceeds the set threshold, and that the failure is caused by water leakage from the washing machine if the number of washing machines having the same alarm within the preset time duration in the preset area does not exceed the set threshold. The automatic determination of a water feeding failure of the washing machine can be implemented and the user experiences are improved.

### BRIEF DESCRIPTION OF DRAWINGS

FIG. 1 is a flowchart illustrating a control method for an Internet-of-Things washing machine according to an embodiment 1;

FIG. 2 is a flowchart illustrating a control method for an Internet-of-Things washing machine according to an embodiment 2;

FIG. 3 is a flowchart of determining a failure cause based on a first number and a second number according to the embodiment 2.

FIG. 4 is a block diagram illustrating a control apparatus for an Internet-of-Things washing machine according to an embodiment 3;

FIG. 5 is a block diagram illustrating a control system for an Internet-of-Things washing machine according to an embodiment 4;

FIG. 6 is a flowchart of determining a failure cause of the Internet-of-Things washing machine according to the embodiment 4; and

FIG. 7 is a schematic diagram illustrating a hardware structure of a server according to an embodiment 5.

In the drawings, 310, information receiving module; 320, first query module; 330, second query module; 340, failure cause determination module; 350, update module; 360, failure cause sending module; 370, failure information sending module;
410, washing machine; 420, server; 430, user terminal;
411, control module; 412, data communication processing module; 413, display module.

### DETAILED DESCRIPTION

The technical solutions of the present disclosure are described hereinafter through specific embodiments in conjunction with the drawings.

### Embodiment 1

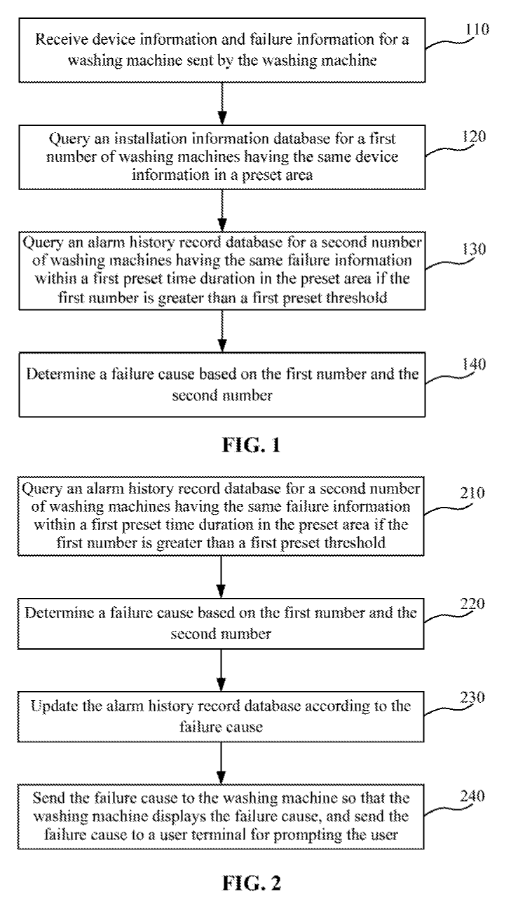

FIG. 1 is a flowchart illustrating a control method for an Internet-of-Things washing machine according to an embodiment 1. The control method includes the steps described below.

In Step 110, device information and failure information of a washing machine sent by the washing machine is received.

The device information includes information for identifying the washing machine. The failure information can indicate a failure displayed by the washing machine. For example, the water feeding is abnormal, an indicator light is not working when the power is turned on, and so on.

In Step 120, an installation information database is queried for a first number of washing machines having same device information in a preset area.

In Step 130, an alarm history record database is queried for a second number of washing machines having same failure information within a first preset time duration in the preset area if the first number is greater than a first preset threshold.

A residential area, a same street or a same building may be selected as the preset area. The first preset time may be a time duration before the washing machine fails, or may be a time duration that is relatively close to time when the washing machine fails, such as a time duration of 10 minutes from the time when the washing machine fails.

In Step 140, a failure cause is determined based on the first number and the second number.

The failure cause of the washing machine may be determined according to value range of the first number and the second number. For example, causes of abnormal water feeding may include: low tap water pressure and loss of tap feedwater; and water leakage from the washing machine.

The failure cause of the washing machine can be determined by the above-mentioned control method instead of by the user himself/herself. Cumbersome work for the user is then reduced and user experiences are improved.

### Embodiment 2

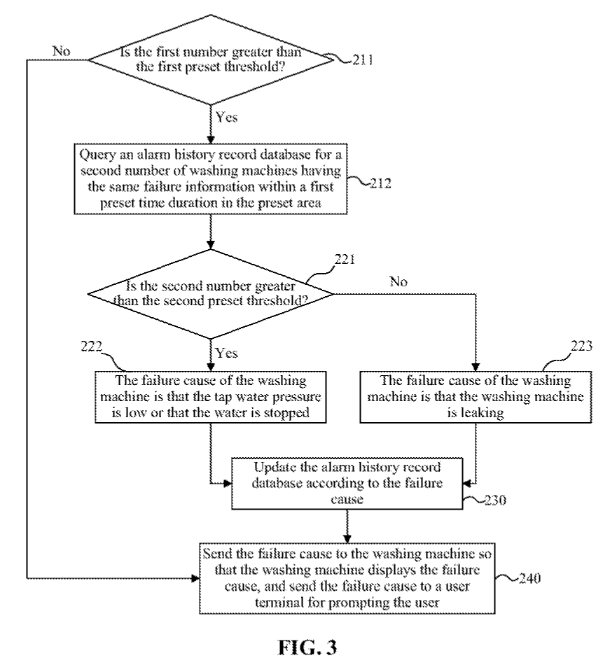

As shown in FIGS. 2 and 3, a flowchart of a control method according to an embodiment 2 includes the steps described below.

In the embodiment, failure information may be that water feeding is abnormal.

On the basis of the above-mentioned embodiment, as shown in FIG. 2, the control method may include the steps below.

In Step 210, an alarm history record database is queried for a second number of washing machines having same failure information within a first preset time duration in the preset area if the first number is greater than a first preset threshold.

In Step 220, a failure cause is determined based on the first number and the second number.

In Step 230, the alarm history record database is updated according to the failure cause.

In Step 240, the failure cause is sent to the washing machine so that the washing machine displays the failure cause, and the failure cause is also sent to a user terminal for prompting a user.

Referring to FIG. 3, the Step 210 may further include the steps described below.

In Step 211, it is determined whether the first number is greater than the first preset threshold. If the first number is greater than the first preset threshold, Step 212 is performed. If the first number is not greater than the first preset threshold, Step 240 is performed.

In the Step 212, an alarm history record database is queried for a second number of washing machines having same failure information within a first preset time duration in the preset area.

In the Step 240, the failure information is sent to the washing machine so that the failure information is displayed on the washing machine, and the failure information is also sent to a user terminal for prompting the user.

Since the number of washing machines in the preset area does not reach a set number, the failure cause cannot be determined by the above-mentioned method.

Based on the above-mentioned embodiment, as shown in FIG. 3, the step in which the failure cause is determined based on the first number and the second number may include the steps described below.

In Step 221, it is determined whether the second number is greater than the second preset threshold. If the second number is greater than the second preset threshold, Step 222 is performed. If the second number is not greater than the second preset threshold, Step 223 is performed.

In the Step 222, the failure cause of the washing machine is that the tap water pressure is low or that the water is stopped, and no after-sale maintenance is required.

In the Step 223, the after-sale personnel is needed to carry out the on-site maintenance.

The maintenance information is sent to the after-sale outlet. The after-sale outlet may actively contact the user for on-site maintenance, avoiding wasting the time of the user.

A relatively accurate determination can be made by using the above-mentioned method for automatically determining the failure cause after the number of washing machines in a certain area reaches a certain number. For example, more than 10 washing machines are set in one area.

### Embodiment 3

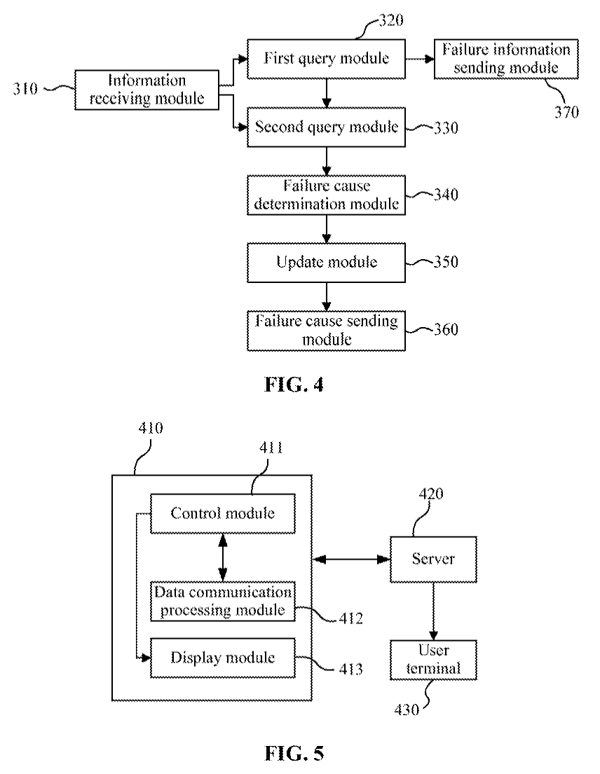

An embodiment provides a control apparatus for an Internet-of-Things washing machine. As shown in FIG. 4, the apparatus implements the control method for an Internet-of-Things washing machine described in the above embodiments. The control apparatus include: an information receiving module 310, a first query module 320, a second query module 330 and a failure cause determination module 340.

The information receiving module 310 is configured to receive device information and failure information of the washing machine sent by the washing machine.

The first query module 320 is configured to query an installation information database for a first number of washing machines having same device information in a preset area.

The second query module 330 is configured to query an alarm history record database for a second number of washing machines having same failure information within a first preset time duration in the preset area if the first number is greater than a first preset threshold.

The failure cause determination module 340 is configured to determine a failure cause based on the first number and the second number.

The failure information may be that water feeding is abnormal. The failure cause determination module 340 may be configured to determine the failure cause of the washing machine as low tap water pressure or loss of feedwater if the second number is greater than a second preset threshold, and determine the failure cause of the washing machine as water leakage from the washing machine if the second number is less than or equal to the second preset threshold.

Optionally, the control apparatus further includes an update module 350. The update module 350 is configured to update the alarm history record database according to the failure cause.

Optionally, the control apparatus further includes a failure cause sending module 360. The failure cause sending module 360 is configured to send the failure cause to the washing machine so that the washing machine displays the failure cause, and send the failure cause to a user terminal for prompting the user.

Optionally, the control apparatus further includes a failure information sending module 370. The failure information sending module 370 is configured to send the failure information to the washing machine so that the washing machine displays the failure information and send the failure information to a user terminal for prompting the user if the first number is less than or equal to the first preset threshold.

### Embodiment 4

As shown in FIG. 5, an embodiment provides a control system for an Internet-of-Things washing machine. The system includes a control apparatus for an Internet-of-Things washing machine 410, the washing machine 410 and a user terminal 430. The control apparatus may be configured in a server 420. The washing machine 410 is configured to determine whether the washing machine 410 fails, and transmit device information and failure information of the washing machine 410 to the server 420 when the washing machine 410 fails.

The washing machine 410 may include a control module 411, a data communication processing module 412 and a display module 413.

The control module 411 is configured to control water feeding of the washing machine 410, determine whether a water level of the washing machine 410 reaches a set value within a second preset time duration, control a water inlet valve to be closed if the water level of the washing machine 410 reaches the set value within the second preset time duration, and control the data communication processing module 412 to send device information and failure information of the washing machine 410 if the water level of the washing machine 410 does not reach the set value within the second preset time duration.

The data communication processing module 412 is configured to transmit the device information and the failure information to the server 420, and receive a failure cause sent by the server 420.

The display module 413 is configured to display the failure cause of the washing machine 410.

The user terminal 430 is configured to receive the failure cause and the failure information sent by the server 420.

The control module 411 and the data communication processing module 412 may be implemented by a central processor, a digital signal processor (DSP) or a field programmable gate array (FPGA). The central processor, the DSP and the FGPA may include a storage medium storing executable instructions for executing the above-mentioned method. The storage medium may be a non-transitory storage medium, including a read-only memory (ROM), a random access memory (RAM) or another medium that may store program codes, and may also be a transitory storage medium. The display module 413 may be a display, such as a liquid crystal display.

The process of determining the failure cause of the water feeding abnormality of the washing machine 410 by using the control system in the embodiment is described below.

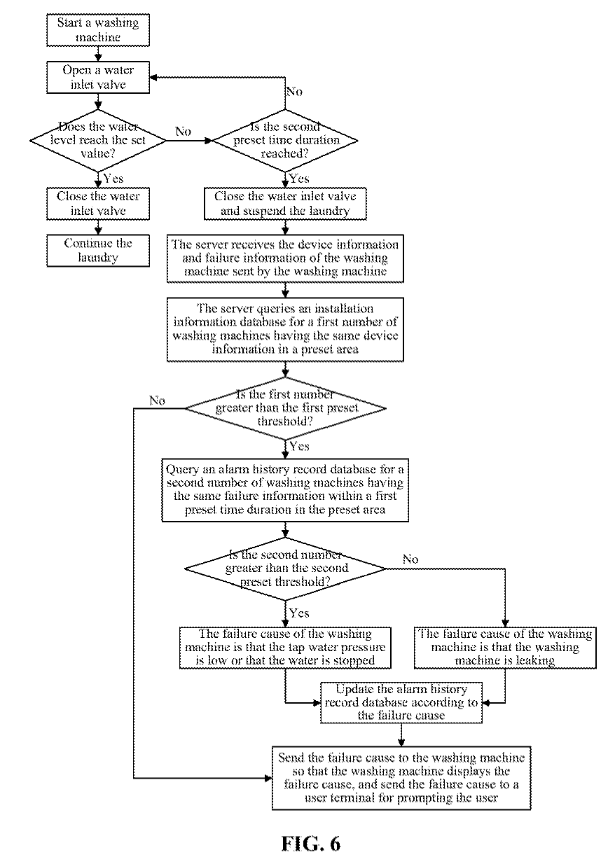

As shown in FIG. 6, the washing machine 410 is started, the water inlet valve is opened, and the control module 411 determines whether the water level of the washing machine 410 reaches the set value. If the water level of the washing machine 410 reaches the set value, the water inlet valve is closed and the laundry is carried out. If the water level of the washing machine 410 does not reach the set value, it is determined whether the second preset time duration is reached. If the second preset time duration is not reached, the water inlet valve is opened for continued water feeding. If the second preset time duration is reached, the water feeding abnormality is indicated, the water inlet valve is closed, the laundry is suspended, and the control module 411 controls the data communication module to transmit the device information and the failure information to the server 420.

The server 420 receives the device information and the failure information of the washing machine 410 sent by the washing machine 410 through the information receiving module, and stores the device information and the failure information of the washing machine 410 in the alarm history record database. The first query module is used to query an installation information database for a first number of washing machines 410 having the same device information in a preset area. If the first number is greater than the first preset threshold, a second query module is used to query the alarm history record database for a second number of washing machines 410 having the same failure information within a first preset time duration in the preset area. The failure cause determination module is used to determine a failure cause based on the first number and the second number. If the first number is less than or equal to the first preset threshold, the failure cause is determined to be water feeding abnormality. The information of water feeding abnormality is sent to the washing machine 410 so that the failure information is displayed through the display module 413 of the washing machine 410, and the failure information is sent to a user terminal 430 for prompting the user.

The step in which the failure cause is determined by the failure cause determination module based on the first number and the second number may include the following steps. If the first number is greater than the second preset threshold, the failure cause of the water feeding abnormality is determined as low tap water pressure or loss of feedwater. The alarm history record database is updated according to the failure cause. The failure cause is sent to the washing machine 410, is displayed through the display module 413 of the washing machine 410, and is sent to the user terminal 430 for prompting the user. If the second number is less than or equal to the second preset threshold, the failure cause of water feeding abnormality is determined as water leakage from the washing machine. The alarm history record database is updated according to the failure cause. The failure cause is sent to the washing machine 410, is displayed through the display module 413 of the washing machine 410, and is sent to the user terminal 430 for prompting the user.

### Embodiment 5

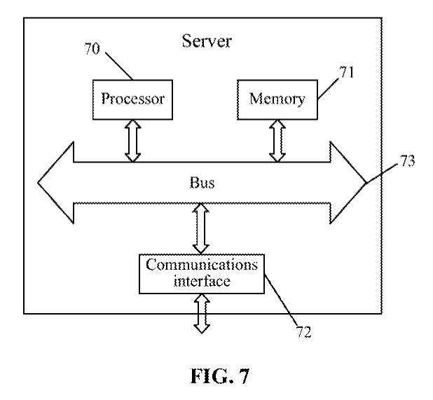

An embodiment provides a schematic diagram illustrating a hardware structure of a server. Referring to FIG. 7, the terminal device includes: at least one processor 70 (FIG. 7 shows one processor 70 by way of example) and a memory 71; and may further include a communications interface 72 and a bus 73. The processor 70, the memory 71 and the communications interface 72 may communicate with each other via the bus 73. Data and signals may be transmitted via the communications interface 72. The processor 70 may call logic instructions in the memory 71 to perform the method of the above-mentioned embodiments.

In addition, the logic instructions in the memory 71 may be implemented in the form of a software function unit and, when sold or used as an independent product, may be stored in a computer-readable storage medium.

As a computer-readable storage medium, the memory 71 may be used for storing software programs and computer-executable programs, such as program instructions or modules corresponding to the method in the above-mentioned embodiments. The processor 70 executes function applications and data processing, that is, to implement the method in the above-mentioned embodiments through running the software programs, instructions or modules stored in the memory 71.

The memory 71 may include a program storage region and a data storage region, where the program storage region may store an operating system and an application program required by at least one function while the data storage region may store data created depending on use of a terminal device. In addition, the memory 71 may include a high-speed random access memory, and may further include a non-volatile memory.

The above-mentioned technical solutions may be embodied in the form of a software product. The computer software product is stored in a storage medium and includes one or more instructions for enabling a computer device (which may be a personal computer, server, network device, etc.) to execute all or part of the steps of the method provided in the above-mentioned embodiments. The foregoing storage medium may be a non-transitory storage medium, including a USB flash drive, a mobile hard disk, a ROM, a RAM, a magnetic disk, an optical disk or another medium that can store program codes, or may also be a transitory storage medium.

### INDUSTRIAL APPLICABILITY

The control method, control apparatus and control system for a washing machine can implement an automatic determination of a water feeding failure of the washing machine and the user experiences are improved.

What is claimed is:

1. A control method for a washing machine, comprising:
receiving device information and failure information of the washing machine sent by the washing machine;
querying an installation information database for a first number of washing machines having same device information in a preset area;
querying an alarm history record database for a second number of washing machines having same failure information within a first preset time duration in the preset ara if the first number is greater than a first preset threshold; and
determining a failure cause based on the first number and the second number.

2. The method of claim 1, wherein the failure information is that water feeding is abnormal.

3. The method of claim 2, wherein the determining the failure cause based on the first number and the second number comprises:
determining the failure cause of the washing machine a low tap water pressure or loss of feedwater if the second number is greater than a second preset threshold, and determining the failure cause of the washing machine as water leakage from the washing machine if the second number is less than or equal to the second preset threshold.

4. The method of claim 3, further comprising: updating the alarm history record database according to the failure cause.

5. The method of claim 4, further comprising: sending the failure cause to the washing machine so that the washing machine displays the failure cause, and sending the failure cause to a user terminal for prompting a user.

6. The method of claim 1, further comprising: sending the failure information to the washing machine so that the washing machine displays the failure information and sending the failure information to a user terminal for prompting a user, if the first number is less than or equal to the first preset threshold.

7. A control apparatus for a washing machine, comprising:
an information receiving module, configured to receive device information and failure information of the washing machine sent by the washing machine;
a first query module, configured to query an installation information database for a first number of washing machines having same device information in a preset area;
a second query module, configured to query an alarm history record database for a second number of washing machines having same failure information within a first preset time duration in the preset area if the first number is greater than a first preset threshold; and
a failure cause determination module, configured to determine a failure cause based on the first number and the second number.

8. The apparatus of claim 2, wherein the failure information is that water feeding is abnormal.

9. The apparatus of claim 8, wherein the failure cause determination module is configured to:
determine the failure cause of the washing machine as low tap water pressure or loss of feedwater if the second number is greater than a second preset threshold, and determine the failure cause of the washing machine as water leakage from the washing machine if the second number is less than or equal to the second preset threshold.

10. A washing machine control system comprising:
a washing machine;
a server comprising a control apparatus for the washing machine, wherein the control apparatus comprises;
an information receiving module, configured to receive device information and failure information of the washing machine sent by the washing machine;
a first query module, configured to query an installation information database for a first member of washing machines having same device information in a preset area;
a second query module, configured to query an alarm history record database for a second number of washing machines having same failure information within a first preset time duration in the preset area if the first number is greater than a first preset threshold; and
a failure cause determination module, configured to determine a failure cause based on the first number and the second number,
wherein the washing machine comprises a control module, a data communication processing module and a display module, wherein the control module is configured to control water feeding of the washing machine, determine whether a water level of the washing machine reaches a set value within a second preset time duration, control a water inlet valve to be closed if the water level of the washing machine reaches the set value within the second preset time duration, and control the data communication processing module to send device information and failure information of the washing machine if the water level of the washing machine does not reach the set value within the second preset time duration; wherein the data communication processing module is configured to transmit the device information and the failure information to the server, and receive a failure cause set by the server, and wherein the display module is configured to display the failure cause of the washing machine; and
a user terminal configured to receive the failure cause and the failure information sent by the server.

11. (canceled)

12. The control system of claim 10, wherein the failure information is that water feeding is abnormal.

13. The control system of claim 12, wherein the failure cause determination module is configured to:
determine the failure cause of the washing machine as low tap water pressure or loss of feedwater if the second number is greater than a second preset threshold, and determine the failure cause of the washing machine as water leakage from the washing machine if the second number is less than or equal to the second preset threshold.
